(19) United States
(12) Patent Application Publication
(10) Pub. No.: US 2007/0019703 A1
(43) Pub. Date: Jan. 25, 2007

(54) Ear thermometer protection lid structure

(76) Inventors: Vincent Weng, HsinChu (TW); Kevin Lin, HsinChu (TW); Joy Liao, Sansing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/527,514

(22) Filed: Sep. 27, 2006

(30) Foreign Application Priority Data
Feb. 12, 2005 (TW) 94142549

(51) Int. Cl. G01J 5/00

(52) U.S. Cl. 374/121

(57) ABSTRACT

An ear thermometer protection lid structure is proposed, in which a lid is disposed on a sensing end of an ear thermometer. When the ear thermometer is used to measure the temperature, the lid is taken off and sleeved onto a grasp end of the ear thermometer to increase the length of the grasp end. The grasp portion of the ear thermometer can thus be lengthened to facilitate grasping and prevent the protection lid from being lost. Moreover, the length of the handle portion can be shortened during manufacturing to lower the cost, and the volume of the ear thermometer can be shrunk to facilitate portability.

### BACKGROUND OF THE INVENTION

1. Field of the invention

The present invention relates to a lid structure and, more particularly, to an ear thermometer protection lid structure capable of increasing the length of the grasp portion.

2. Description of Related art

With the continual progress of science and technology, tools for measuring the body temperature have developed from conventional mercury thermometers to various different body thermometers such as forehead thermometers, ear thermometers, infrared thermal imagers, and so on. An ear thermometer makes use of the infrared light to detect heat emitted by the ear drum to get the body temperature of the subject. Because the ear drum is located in the skull and near the body temperature control center (i.e., hypothalamus) and gets enough supply of blood from the carotid arteries, any variation of the core temperature of the body can be known immediately from the temperature response of the ear drum. The ear temperature can be used to figure out the oral temperature or the anal temperature as of references of temperature. Because the ear thermometers have the advantages of quick measurement, high accuracy and easy operation, they have gradually become one of the mainstream methods for measuring the body temperature.

When measuring the ear temperature of a subject using a conventional ear thermometer, a probe head of the ear thermometer is placed into the ear canal of the subject. Through detection of infrared EM waves radiated from the human body, the body temperature can be deduced. Therefore, protection measures for the probe head are required. When the conventional ear thermometer is not in use, a protection lid will cover on the probe head to isolate the probe head from the outside. Until the next time of use, the protection lid is taken off for the measurement of the body temperature. After the measurement of the body temperature is finished, however, the user usually forgets to cover the protection lid back on the ear thermometer, resulting in loss of the protection lid and thus shortening the lifetime of use of the ear thermometer. Moreover, the actual part of the conventional ear thermometer for measuring the body temperature is limited to the probe head at one end, and the other end is only used to display the temperature and facilitate grasping. In order to facilitate grasping, the grasp portion of the conventional ear thermometer is improved (e.g., increasing the length, curvature and width), making the ear thermometer bulky and thus resulting in difficulty storage and placement.

Accordingly, the present invention aims to propose an ear thermometer protection lid structure to effectively solve the above problems of conventional ear thermometers.

### SUMMARY OF THE INVENTION

An object of the present invention is to provide an ear thermometer protection lid structure capable of increasing the length of the grasp portion. When a user measures the body temperature, the protection lid is placed at the tail of the grasp portion of the ear thermometer to lengthen the grasp portion, thereby facilitating grasping and preventing the protection lid from being lost.

Another object of the present invention is to provide an ear thermometer protection lid structure capable of lowering the cost. Because the ear thermometer can be elongated through the protection lid, the length of the handle portion can be shortened during manufacturing to lower the cost, and the volume of the ear thermometer can be shrunk to facilitate portability.

To achieve the above objects, the present invention provides an ear thermometer protection lid structure, which is disposed on an ear thermometer body. The ear thermometer body has a sensing end and a grasp end. A lid covers on the sensing end. When the ear thermometer body is used to measure the body temperature, the lid is taken off and sleeved onto the grasp end to increase the length of the grasp end.

### BRIEF DESCRIPTION OF THE DRAWINGS

The various objects and advantages of the present invention will be more readily understood from the following detailed description when read in conjunction with the appended drawing, in which:

FIG. 1 is a diagram of the lid of the present invention when covering on the sensing end;

FIG. 2 is a diagram of the lid of the present invention when covering on the grasp end; and

FIG. 3 is a diagram according to another embodiment of the present invention.

### DETAILED DESCRIPTION OF THE PREFERRED EMBODIMENTS

The present invention provides an ear thermometer protection lid structure, which is disposed on an ear thermometer. The protection lid structure can protect a probe head of the ear thermometer when the ear thermometer is not in use. When the ear thermometer is in use, the protection lid structure can be sleeved onto a grasp portion of the ear thermometer to increase the length of the grasp portion of the ear thermometer, thereby facilitating grasping when a user operates the ear thermometer and preventing the protection lid from being lost.

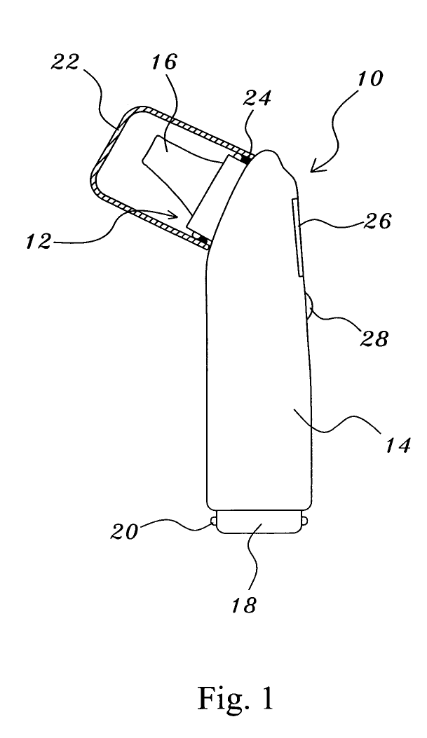

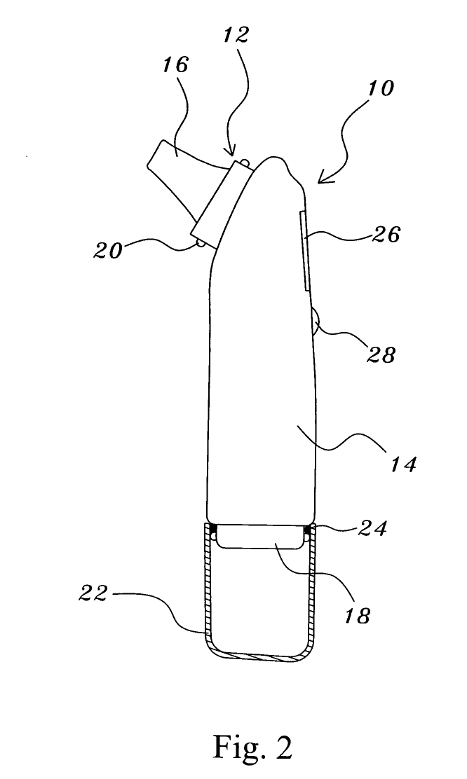

As shown in FIGS. 1 and 2, the ear thermometer protection lid structure is disposed on an ear thermometer body 10. The ear thermometer body 10 has a sensing end 12 and a grasp end 14. The sensing end 12 has a probe head 16. The grasp end 14 has a protuberance 18. A locking piece 20 is disposed on the sensing end 12 and at the bottom end of the probe head 16. A locking piece 20 is also disposed on the protuberance 18 of the grasp end 14. The locking pieces 20 are annularly arranged at the bottom of the probe head 16 and on the protuberance 18, respectively.

A lid 22 made of plastic material covers on the sensing end 12. The lid 22 can sheathe the probe head 16 to isolate the probe head 16 from the outside. A fastening portion 24 is disposed at the inner edge of the lid 22. When the lid 22 covers on the sensing end 12, the fastening portion 24 of the lid 22 can be locked with the locking piece 20 at the bottom end of the probe head 16 to lock the lid 22 on the sensing end 12. The ear thermometer body 10 has also a display 26 and a control interface 28. The display 26 can display the measured temperature data. The control interface 28 can be operated by a user. The control interface 28 makes use of a plurality of press-buttons for operation.

When the ear thermometer is in use, the lid 22 is taken off from the sensing end 12 and sleeved onto the grasp end 14. When the lid 22 is sleeved onto the grasp end 14, the fastening portion 24 of the lid 22 can be locked with the locking piece 20 of the protuberance 18 to lock the lid 22 on the grasp end 14, and also increase the length of the grasp end 14.

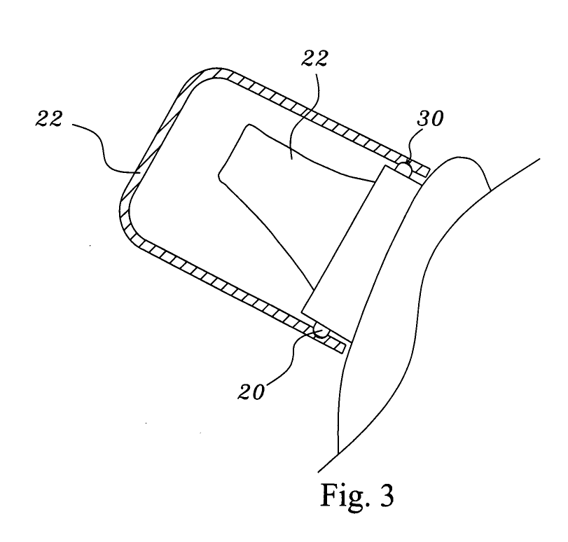

FIG. 3 is a diagram according to another embodiment of the present invention. This embodiment differs from the above embodiment in that a fastening groove 30 is disposed on the sensing end 12 and at the bottom end of the probe head 16, and a fastening groove 30 is similarly disposed on the protuberance 18 of the grasp end 14. When the lid 22 covers on the sensing end 12 or the grasp end 14, the fastening portion 24 of the lid 22 can be locked with the fastening groove 30 at the bottom end of the probe head 16 or the protuberance 18 to lock the lid 22 on the sensing end 12 or the grasp end 14.

To sum up, the lid structure of the present invention allows the user to place the protection lid at the tail end of the grasp portion of the ear thermometer so as to lengthen the grasp portion when measuring the body temperature, thereby facilitate grasping and preventing the lid from being lost. Moreover, because the ear thermometer can be elongated through the protection lid; the length of the handle portion can be shortened during manufacturing to lower the cost and save space, and the volume of the ear thermometer can be shrunk to facilitate portability.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An ear thermometer protection lid structure disposed on an ear thermometer body, said ear thermometer body having a sensing end and a grasp end, a lid being disposed on said sensing end, said lid being taken off and fixedly sleeved onto said grasp end to be grasped by a user when said ear thermometer body is used for ear temperature measurement;
wherein a fastening portion is disposed at an inner edge of said lid to make said lid fastened on said sensing end or said grasp end; and
wherein said grasp end has a protuberance, at least a locking piece or at least a fastening groove is disposed on said protuberance, and said fastening portion is locked with said locking piece or said fastening groove when said lid covers on said protuberance

2. The ear thermometer protection lid structure as claimed in claim 1, wherein said sensing end has a probe head, at least a locking piece or at least a fastening groove is disposed at a bottom end of said probe head, and said fastening portion is locked with said locking piece or said fastening groove when said lid covers on said sensing end.

3. The ear thermometer protection lid structure as claimed in claim 2, wherein said lid can sheathe said probe head when covering on said sensing end.

4. The ear thermometer protection lid structure as claimed in claim 1, wherein said lid is made of plastic material.

5. The ear thermometer protection lid structure as claimed in claim 1, wherein said ear thermometer body has a display for displaying the temperature data.

6. The ear thermometer protection lid structure as claimed in claim 1, wherein said ear thermometer body has a control interface to be operated by a user.

7. The ear thermometer protection lid structure as claimed in claim 6, wherein said control interface has at least a push-button.
